(19) United States
(12) Patent Application Publication
(10) Pub. No.: US 2015/0303608 A1
(43) Pub. Date: Oct. 22, 2015

(54) Latched Connector Assembly with a Release Mechanism

(71) Applicant: FCI Americas Technology LLC, Carson City, NV (US)

(72) Inventors: Arkady Zerebilov, Etters, PA (US); Deborah Ingram, Etters, PA (US)

(73) Assignee: FCI Americas Technology LLC, Carson City, NV (US)

(21) Appl. No.: 14/438,676

(22) PCT Filed: Oct. 29, 2013
(86) PCT No.: PCT/EP13/72581

§ 371 Date: Apr. 27, 2015

Related U.S. Application Data
(60) Provisional application No. 61/719,674, filed on Oct. 29, 2012.

(51) Int. Cl. H01R 13/502; H01R 13/627

(52) U.S. Cl. CPC H01R 13/502; H01R 13/6273

(57) ABSTRACT

A connector assembly of a first and a complementary second connector. The assembly includes latches cooperative with respective matching locking sections at opposite sides of the assembly to hold the connectors in an assembled state. One of the connectors includes a main body and a release member which is slideable relative to the main body between a rest position and a release position. In the release position the release member disengages the latches from the respective locking sections. At least one resilient member biases the release member to the rest position.

### FIELD OF THE INVENTION

The present invention relates to a connector assembly comprising a pair of complementary connectors and one or more latches on one connector cooperating with a locking section of the other connector to hold the two connectors in an assembled state. The invention also relates to the individual connectors such as a header connector and a receptacle connector.

### BACKGROUND OF THE INVENTION

The connector assemblies can for example be optical or electrical connector assemblies, such as cable-to-board connectors. Locking mechanisms, typically including a latch or a pair of symmetrically arranged latches, serve to avoid unintentional disconnection. A release mechanism can be provided to unlock the latches in case the connectors should be disconnected.

It is generally desirable to position a plurality of assemblies closely together, e.g., on a printed circuit board or a similar substrate. This requires compact connector assemblies. Lock and release mechanisms consume volume and result in less compact connectors with more parts. With lock and release mechanisms the obtainable connector density is further limited by finger space required for manual actuation of the lock and release mechanisms.

It is an object of the invention to provide a connector assembly with a robust, compact and easy to operate lock and release mechanism.

### SUMMARY OF THE INVENTION

A connector assembly is provided of two complementary connectors, the assembly comprising latches cooperative with respective matching locking sections at opposite sides of the assembly to hold the connectors in an assembled state. One of the connectors comprises a main body and a release member slideable relative to the main body between a rest position and a release position where it disengages the latches from the respective locking sections. At least one resilient member biases the release member to the rest position. Such a release member can be designed in a very compact way, e.g. in one single piece, reducing the total number of parts of the connector. Such a release member can for instance be made in a very cost efficient way by stamping and bending a blank of a sheet material. Since the latches are at opposite sides of the assembly, a balanced retention is obtained.

In a specific embodiment, the one or more resilient members of the release member can be positioned at a side face of the assembly between the two opposite side faces with the latches. For instance, the resilient members can be positioned at the top face and/or at the lower face, while the latches and the respective locking sections are positioned at opposite side faces. Since the latches and the release members are at different side faces of the assembly, the release member can be made very flat. The lock and release mechanisms can be made robust without consuming more space.

The at least one resilient member can for instance be a spring, such as a cantilever leaf spring, resiliently abutting a portion, such as a projection, of the main body to bias the release member to the rest position. The projection flexes the cantilever spring leafs when the release member is pulled.

Optionally, the release member comprises a pull tab for moving the release member from the locking position to the release portion against the action of the at least one resilient member. The at least one resilient member can be coplanar with the pull tab.

Disassembling can be simplified if the release member is slideable relative to the main body of the second connector in a direction corresponding to a mating direction of the two connectors. Actuating the release member and disconnecting the connectors can be realized in a single move.

In a specific embodiment the locking section comprises at least one ridge and the latch comprises a cam locking behind the at least one ridge, wherein the release member comprises a pressure surface shaped to gradually increase lateral pressure flexing the latch aside to the release the at least one ridge.

The latches can for instance be positioned at side faces of the assembly, wherein the release member comprises a top face linked to the pull tab, with the at least one cantilever leaf springs forming part of the top face, the top face being flanked by downwardly extending side faces partly covering side faces of the main body of the second connector. In such a configuration the top face of the release member can for example comprise a central strip and a pair of parallel side strips extending laterally between each side face and the central strip, and wherein two oppositely directed cantilever leaf springs extend from the central strip. The two cantilever leaf springs may extend between the two side strips with a resiliently moveable free end near the side face of the main body of the second connector.

In a specific embodiment the latch comprises two parallel legs spaced by a gap, each with a flexible free end and an opposite end fixed to the main body of the first connector, wherein the latch comprises a cam bridging the free ends of the two legs. With such a latch, the locking section of the second connector an be designed to comprise two ridges facing the cam at top ends of the latch legs, wherein the ridges and the and the cam have mutually abutting contact faces under a blunt angle with a mating direction of the connector assembly. The release member may comprise a pressure surface positioned between the two spaced ridges of the locking section of the second connector when the connectors are in an assembled state. This pressure surface can be dimensioned to gradually increase lateral pressure to the cam flexing the latch aside to the release the spaced ridges. To this end, the pressure surface can for example be bulging or slanting under a sharp angle with the mating direction.

### BRIEF DESCRIPTION OF THE DRAWINGS

An exemplary embodiment of a connector assembly according to the present invention is further explained under reference to the accompanying drawings.

FIG. 1: shows an exemplary embodiment of a connector assembly comprising a header connector and a receptacle connector in an assembled state;

FIG. 2: shows in detail the receptacle connector of the assembly of FIG. 1;

FIG. 3: shows in detail the header connector of the assembly of FIG. 1;

FIG. 4: shows in detail the latch of the connector assembly of FIG. 1;

FIG. 5: shows the release member of the assembly of FIG. 1;

FIG. 6: shows in cross section the latch of FIG. 5 during movement to the release position.

### DETAILED DESCRIPTION OF AN EXEMPLARY EMBODIMENT

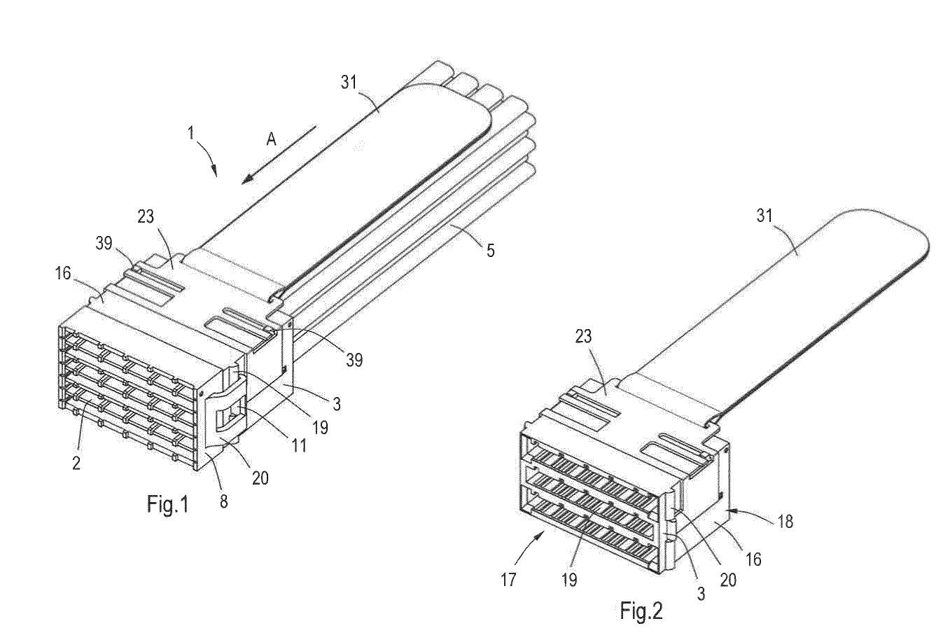

FIG. 1 shows a connector assembly 1 of a header connector 2 and a complementary receptacle connector 3, shown apart in FIG. 2. The two connectors 2, 3 can be assembled by moving the two together in a mating direction, indicated by arrow A.

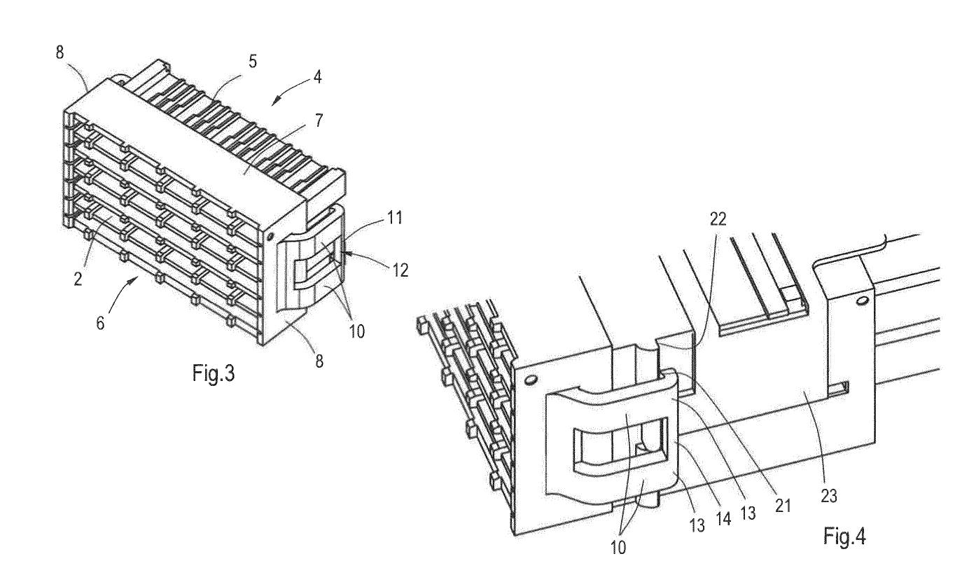

The first connector 2 (see FIG. 3) has a mating side 4 with protruding contacts 5, and a mounting side 6 for mounting the connector 2 to a printed circuit board or a similar substrate (not shown). The first connector 2 comprises a main body 7 two lateral side faces 8, both provided with a latch 9. The latches 9 point in a direction opposite to the mating direction A. The latches 9 are symmetrically arranged and have two legs 10 with one end fixed to the main body 7 and a resiliently movable free ends bridged by a cam 11. The two legs 10 of the latch 9 are spaced by a gap 12. The cams 11 of the two latches 9 at the respective side faces 8 point in each others direction. The cams 11 have a middle section 13 at the end of the gap 12 between two lateral sections 14 at the end of the latch legs 10 (see FIG. 4 and FIG. 6).

The second connector 3 (see FIG. 2) comprises a main body 16 with one end connected to a series of cables 5 (see FIG. 1) and an opposite mating end 17 dimensioned to receive the mating side 4 of the first connector 2. Side faces 18 of the main body 16 are provided with a locking section 19 cooperating with the latches 9 to hold the two connectors 2, 3 in an assembled state.

The locking section 19 is formed by a pair of spaced ridges 20 on the main body 12 of the second connector 3. The ridges 20 are spaced by a gap of the same width as the gap 12 between the latch legs 10. The cam 11 of the latch 9 and the locking section 19 have mutually abutting parallel contact faces 21, 22 (see FIG. 4) substantially perpendicular to the mating direction A to prevent unintentional disengagement.

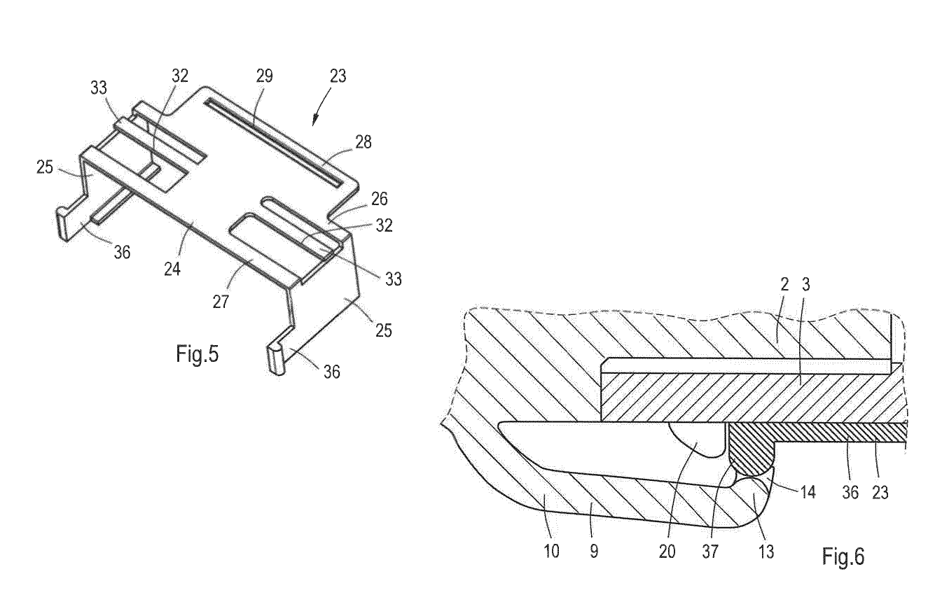

The second connector 3 further comprises a release member 23 which is slideable relative to the main body 16 of the second connector 3. The release member 23 can be moved between a rest position and a release position. FIG. 5 shows the release member 23 as a separate part. The release member 23 comprises a central strip 24 centrally positioned on top of the top face of the main body 16, and two side webs 25 covering part of the side faces of the main body 16 of the second connector 3. The ends of the central strip 24 and the ends of the side webs 25 are bridged by parallel transversal strips 26, 27. The transversal strip 26 at the cable side is provided with a slotted extension 28 with a slot 29 running parallel to the transversal strips 26, 27. A pull tab 31 is tied to the slot 29 in the slotted extension 28 (see FIG. 2).

Symmetrically arranged cantilever leaf springs 32 extend from both sides of the central strip 24 of the release member 20 in a direction parallel to the transversal strips 26, 27. The cantilever leaf springs 32 have a free outer end 33 which can be resiliently flexed relative to the central strip 24 of the release member 20. The free ends 33 of the cantilever leaf springs 32 abut a projection 34 on the top face of the main body 16 adjacent the side faces of the main body 16. If a user pulls the pull tab 31 the projections 34 will spring load the flexing cantilever leaf springs 32 biasing the release member 23 to its rest position, as shown in FIG. 1.

The lower edges of the side webs 25 of the release member 23 are extended by extensions 36 pointing in mating direction A. The outer ends of these side web extensions 36 are positioned within the interruption between the ridges 20 forming the locking section 19 of the main body 16. The outer ends of the extensions 36 comprise a slanting or bulging surface 37 dimensioned to push the latch 9 aside when it is moved in a direction opposite to the mating direction A (see FIG. 6).

When a user pulls the pull tab 31, the outer ends 37 of the side web extensions 36 of the release member 23 push aside the central section 13 of the cams of the latches 9, releasing the ridges 20 of the main body 16 of the second connector 3, while the cantilever leaf springs 33 are flexed and generate a spring force pulling the main body 16 of the second connector 3 away from the first connector 2. As a result, the second connector 3 will be separated from the first connector 2.

1. A connector assembly of a first and a complementary second connector, the assembly comprising latches cooperative with respective matching locking sections at opposite sides of the assembly to hold the connectors in an assembled state, one of the connectors comprising a main body and a release member slideable relative to the main body between a rest position and a release position where it disengages the latches from the respective locking sections, wherein at least one resilient member biases the release member to the rest position.

2. A connector assembly according to claim 1 wherein the at least one resilient member is a spring resiliently abutting a portion of the main body to bias the release member to the rest position.

3. A connector assembly according to claim 2 wherein the at least one resilient member is a cantilever leaf spring with a free end abutting a projection on the main body.

4. A connector assembly according to claim 1, wherein the release member comprises a pull tab for moving the release member from the locking position to the release portion against the action of the at least one resilient member.

5. A connector assembly according to claim 4 wherein the at least one resilient member is in line with the pull tab in pulling direction.

6. A connector assembly according to claim 5 wherein the latches are positioned at side faces of the assembly and wherein the release member comprises a top face linked to the pull tab, with the at least one cantilever leaf springs forming part of the top face, the top face being flanked by downwardly extending side faces partly covering side faces of the main body of the second connector.

7. A connector assembly according to claim 6 wherein the top face of the release member comprises a central strip and a pair of parallel side strips extending laterally between each side face and the central strip, and wherein two oppositely directed cantilever leaf springs extend from the central strip.

8. A connector assembly according to claim 7 wherein the two cantilever leaf springs extend between the two side strips with a resiliently moveable free end near the side face of the main body of the second connector.

9. A connector assembly according to claim 1 wherein at least one of the resilient members is an integral part of the release member.

10. A connector assembly according to claim 1 wherein the release member is slideable relative to the main body of the second connector in a direction corresponding to a mating direction of the two connectors.

11. A connector assembly according to claim 1 wherein the locking section comprises at least one ridge and the latch comprises a cam locking behind the at least one ridge, wherein the release member comprises a pressure surface shaped to gradually increase lateral pressure flexing the latch aside to the release the at least one ridge.

12. A connector assembly according to claim 1 wherein the at least one latch comprises two parallel legs spaced by a gap, each with a flexible free end and an opposite end fixed to the main body of the first connector, wherein the latch comprises a cam bridging the free ends of the two legs.

13. A connector assembly according to claim 12 wherein the locking section of the second connector comprises two ridges facing the cam at top ends of the latch legs, wherein the ridges and the and the cam have mutually abutting contact faces under a blunt angle with a mating direction of the connector assembly.

14. A connector assembly according to claim 13 wherein the release member comprises a pressure surface positioned between the two spaced ridges of the locking section of the second connector when the connectors are in an assembled state, wherein the pressure surface is dimensioned to gradually increase lateral pressure to the cam flexing the latch aside to the release the spaced ridges.

15. A connector assembly according to claim 1 comprising two symmetrically arranged latches and two symmetrically arranged springs.

16. A connector assembly according to claim 15 wherein the pressure surface is a bulging surface.

17. A header connector for use in a connector assembly according to claim 1.

18. A receptacle connector for use in a connector assembly according to claim 1.
